(19) United States
(12) Patent Application Publication
(10) Pub. No.: US 2013/0070900 A1
(43) Pub. Date: Mar. 21, 2013

(54) COMBINE APPARATUS OF SCANNING ELECTRON MICROSCOPE AND ENERGY DISPERSIVE X-RAY SPECTROSCOPY

(71) Applicant: Jun-Hee Lee, Daejeon (KR)

(72) Inventor: Jun-Hee Lee, Daejeon (KR)

(73) Assignee: COXEM CO., LTD., Daejeon (KR)

(21) Appl. No.: 13/698,768

(22) PCT Filed: Oct. 19, 2011
(86) PCT No.: PCT/KR2011/007773

§ 371 Date: Nov. 19, 2012

(30) Foreign Application Priority Data
Apr. 14, 2011 (KR) 10-2011-0034810

(51) Int. Cl. G01T 1/36

(52) U.S. Cl. 378/82

(57) ABSTRACT

Disclosed is a combine apparatus of a scanning electron microscope and an energy dispersive x-ray spectroscopy in that the scanning electron microscope and the energy dispersive x-ray are combined, whereby unifying as one apparatus. The combine apparatus of the scanning electron microscope and the energy dispersive x-ray spectroscopy includes: an image generation means for detecting electrons emitted from a sample for measuring a shape of the sample and simultaneously generating a scanning electron microscope image for analyzing an x-ray; a controller for generating a display control signal and a specific position storing control signal of the image generated from the image generation means; and an x-ray measuring circuit for accumulating an energy level on a specific position of the image generated from the image generation means according to the specific position storing control signal generated by the controller to provide an element information thereof.

### TECHNICAL FIELD

The present invention relates to a combine apparatus of a scanning electron microscope and an energy dispersive x-ray spectroscopy, more particularly to a combine apparatus of a scanning electron microscope and an energy dispersive x-ray spectroscopy in that the scanning electron microscope and the energy dispersive x-ray are combined, whereby unifying as one apparatus.

### BACKGROUND ART

Generally, a scanning electron microscope (SEM) serves to detect a secondary electron or a back scattered electron having a high occurring probability among various signals generated from a sample when the scanning line is scanned on the surface of the sample and implements an image based on the amount of the detected electrons, thereby providing image information on the sample through a series of the above process and measuring the object sample.

In the scanning electron microscope (SEM), the sample can be observed as an image, so that the surface information of the sample can be obtained. Also, there are merits in that it is not restricted to the thickness, size, and shape thereof.

In the meantime, an energy dispersive x-ray spectroscopy attached to the scanning electron microscope (SEM) is an equipment for measuring all elements or a part thereof measured as an image. That is, the energy dispersive x-ray spectroscopy is utilized as a qualitative analysis such as a component analysis of the sample. When the electron is collided on the sample, various kinds of electrons, ions, and specific x-rays etc. are emitted to outside. At this time, the energy dispersive x-ray spectroscopy detects only the emitted x-ray and accumulates and writes the energy of the x-ray per each object position. Here, since the intensity of the specific x-ray accumulated per each object position is an eigen value thereof, it compares the energy value with the specific value of the matter inputted in advance, thereby inferring the matching matters.

As is generally known, two apparatuses have the mutually cooperative relationship. However, since the scanning electron microscope and the energy dispersive x-ray spectroscopy are different from each other in terms of basically technical principals and manufacturer's area, they are operated side by side, but are not integrally manufactured.

FIG. 1 is a sectional view illustrating a structure of a general scanning electron microscope. As shown in FIG. 1, the general scanning electron microscope includes a chamber 10 for placing a sample 11, which is a measuring object, therein and forming a vacuum space, a scanning body 20 for scanning an electron beam on the sample 11 connected to the upper portion of the chamber 10, and an electron detector 30 for detecting an electron generated from the electron beam collided on the sample 11.

Also, where the general scanning electron microscope goes side by side with an x-ray detector 40, it can combine the chamber 10 for placing the sample 11, which is a measuring object, therein and forming the vacuum space, the scanning body 20 for scanning the electron beam on the sample 11 connected to the upper portion of the chamber 10, and the electron detector 30 for detecting the electron generated from the electron beam collided on the sample 11 with the x-ray detector 40 for detecting an x-ray generated from the electron beam collided on the sample 11.

As is generally known, looking into the general scanning electron microscope, it seems that the electron detector 30 and the x-ray detector 40 are just combined into one equipment. However, actually, the manufacturer of the scanning electron microscope purchases only the x-ray spectroscopy from the manufacturer of the x-ray spectroscopy separately and then, they are only connected to each other. Accordingly, it will be explained in detail below, but the electron detecting circuit and the x-ray detecting circuit are separately divided, so that the scanning electron microscope can serve to measure the shape of the sample through an image observation and the x-ray spectroscopy can serve to analyze the component of the objective sample, thereby operating two equipment separately.

The operation of the scanning electron microscope and the x-ray detector going side by side with the scanning electron microscope will be briefly described below. The electron beam is scanned on the sample 11 through the scanning body 20 and the electron detector 30 and the x-ray detector 40 detect the electron and the x-ray respectively to measure the shape of the sample and analyze the components thereof. At this time, in order to observe the sample to the minute, generally, images are displayed through a visual media such as a monitor for displaying the images and rectangular scanning areas of a same shape. However, the electron passed through a magnetic lens is rotated and moved in the direction of a spiral helix due to the influence of the Lorentz force as shown in FIG. 2, so that the rectangular scanning area of the actual sample is not observed owing to the rotation and the distortion thereof.

Accordingly, it requires a compensation circuit for scanning the rectangular scanning areas of a same shape, which are displayed on the screen, on the sample.

FIG. 3 is an example view illustrating an example in that a normal sample scanning line of the generated scanning line is created by generating a compensated scanning line through a compensation circuit.

FIG. 4 is an example view illustrating an example in that a compensation circuit is applied to an energy dispersive x-ray spectroscopy when a scanning electron microscope goes side by side with the energy dispersive x-ray spectroscopy.

As shown in FIG. 4, in order to analyze the components of the entire sample or a partial area of the sample, which is displayed on the monitor as the image, it is inevitably shown that the compensation circuit of the scanning electron microscope should be used in the energy dispersive x-ray spectroscopy. That is, only the scanning electron microscope can see the rotation and the distortion of the scanning line distorted by the Lorentz force for the component analysis in a location corresponding to the image. Accordingly, in order to analyze the components of the entire sample or a partial area of the sample, which is displayed on the monitor as the image, the entire scanning line 51 or the partial scanning line 52 generated from the energy dispersive x-ray spectroscopy are scanned on the sample through a switch 54 and the compensation circuit 53 of the scanning electron microscope. At this time, the generated x-ray energy is cumulatively recorded (55) to analyze the component thereof.

FIG. 5 is a circuit diagram of a general scanning electron microscope. As shown in FIG. 5, the circuit of the scanning electron microscope includes a scanning line generation circuit 61, a compensation circuit 62 for generating a compensated scanning line against the generated scanning line and compensating it, and an image generation circuit 63 for generating an image of the sample.

FIG. 6 is a circuit diagram of a general energy dispersive x-ray spectroscopy. As shown in FIG. 6, the circuit of the energy dispersive x-ray spectroscopy includes a scanning line generation circuit 71 for generating a scanning line of a specific image position, a compensation circuit 72 for generating a compensated scanning line against the generated scanning line and compensating it, an image generation circuit 73 for generating an image of the sample, and x-ray measuring circuit 74 for accumulating an energy level of a specific position in the image generated from the image generation circuit 73. Here, the compensation circuit 72 of the energy dispersive x-ray spectroscope cannot be independently implemented therein. That is, the energy dispersive x-ray spectroscope should borrow the compensation circuit 62 of the scanning electron microscope at any cost.

In the existed scanning electron microscope and energy dispersive x-ray spectroscope, although the scanning line generation circuits 61 and 71 and the image generation circuits 63 and 73 are overlapped in terms of function thereof, they are manufactured as separated boards and operation software (two computers and monitors) in each manufacturing company to perform the image measurement of the sample and the component analysis.

Here, it is complicated and costs much to manufacture the boards of the scanning line generation circuit and the image generation circuit. Accordingly, although the overlapped constructions are existed between the energy dispersive x-ray spectroscope and the scanning electron microscope, since they are separately manufactured, it has enormous costs to manufacture each equipment and they take up too much space. Also, there is a defect in that the usage thereof is complicated owing to two equipments.

Moreover, recently, a physical combination thereof is required in a state that the reciprocal technical areas are preserved.

### DISCLOSURE OF INVENTION

### Technical Problem

Accordingly, the present invention has been made to solve the above-mentioned problems occurring in the prior art, and an object of the present invention is to provide a combine apparatus of a scanning electron microscope and an energy dispersive x-ray spectroscopy in that the scanning electron microscope and the energy dispersive x-ray are combined, whereby unifying as one apparatus.

Another object of the present invention is to provide a combine apparatus of a scanning electron microscope and an energy dispersive x-ray spectroscopy in that the overlapped functions of the scanning electron microscope and the energy dispersive x-ray are unified.

### Solution to Problem

To accomplish the objects, the present invention provides a combine apparatus of a scanning electron microscope and an energy dispersive x-ray spectroscopy includes: an image generation means for detecting electrons emitted from a sample for measuring a shape of the sample and simultaneously generating a scanning electron microscope image for analyzing an x-ray; a controller for generating a display control signal and a specific position storing control signal of the image generated from the image generation means; and an x-ray measuring circuit for accumulating an energy level on a specific position of the image generated from the image generation means according to the specific position storing control signal generated by the controller to provide an element information thereof.

Preferably, the image generation means is the scanning electron microscope for detecting the electrons emitted from the sample and generating the image for measuring the shape of the sample.

Preferably, the image generation means includes: a scanning line generation circuit for generating a scanning line, a compensation circuit for compensating a rotation and a distortion of the generated scanning line, and an image generation circuit for detecting the electrons emitted from the sample after the scanning line compensated by the compensation circuit is scanned on the sample and simultaneously generating the scanning electron microscope image for measuring the sample and the image for analyzing the x-ray.

Preferably, the controller allows the next accumulated signal or the next period signal to be provided to the x-ray measuring circuit as the specific position storing control signal.

Preferably, the x-ray measuring circuit is the energy dispersive x-ray spectroscopy for utilizing the image provided from the scanning electron microscope without being equipped with a separate image generation means.

### Advantageous Effects of Invention

According to the combine apparatus of scanning electron microscope and energy dispersive x-ray spectroscopy, there is an effect in that the scanning electron microscope and the energy dispersive x-ray are combined, whereby unifying as one apparatus.

According to the combine apparatus of scanning electron microscope and energy dispersive x-ray spectroscopy, since the scanning electron microscope and the energy dispersive x-ray can be unified as one apparatus, it can solve the conventional complication owing to the separate manufacturing of the boards of the scanning electron microscope and the energy dispersive x-ray, thereby reducing the cost consumed in the separate manufacturing thereof.

According to the combine apparatus of scanning electron microscope and energy dispersive x-ray spectroscopy, during the manufacturing of the board of the energy dispersive x-ray spectroscopy, since the scanning line generation circuit and the image generation circuit, which are overlapped to the scanning electron microscope, are removed, the board of the energy dispersive x-ray spectroscopy can be manufactured as only the x-ray measuring circuit, thereby easily manufacturing the board of the energy dispersive x-ray spectroscopy.

According to the combine apparatus of scanning electron microscope and energy dispersive x-ray spectroscopy, since the scanning electron microscope and the energy dispersive x-ray can be unified as one board, it can minimize the installation space and provide a convenience in a use thereof.

### BRIEF DESCRIPTION OF DRAWINGS

The above as well as the other objects, features and advantages of the present invention will be more apparent from the following detailed description taken in conjunction with the accompanying drawings, in which:

FIG. 1 is a sectional view illustrating a structure of a general scanning electron microscope;

FIG. 2 is an example view for explaining a rotation and a distortion of a scanning line in the scanning electron microscope of FIG. 1;

FIG. 3 is an example view illustrating an example in that the scanning line having the rotation and the distortion is compensated in the scanning electron microscope of FIG. 1;

FIG. 4 is an example view illustrating an example in that a compensation circuit of the scanning electron microscope of FIG. 1 is applied to an energy dispersive x-ray spectroscopy;

FIG. 5 is a circuit diagram of a general scanning electron microscope;

FIG. 6 is a circuit diagram of a general energy dispersive x-ray spectroscopy; and

FIG. 7 is a schematic block diagram illustrating a combine apparatus of a scanning electron microscope and an energy dispersive x-ray spectroscope according to the present invention.

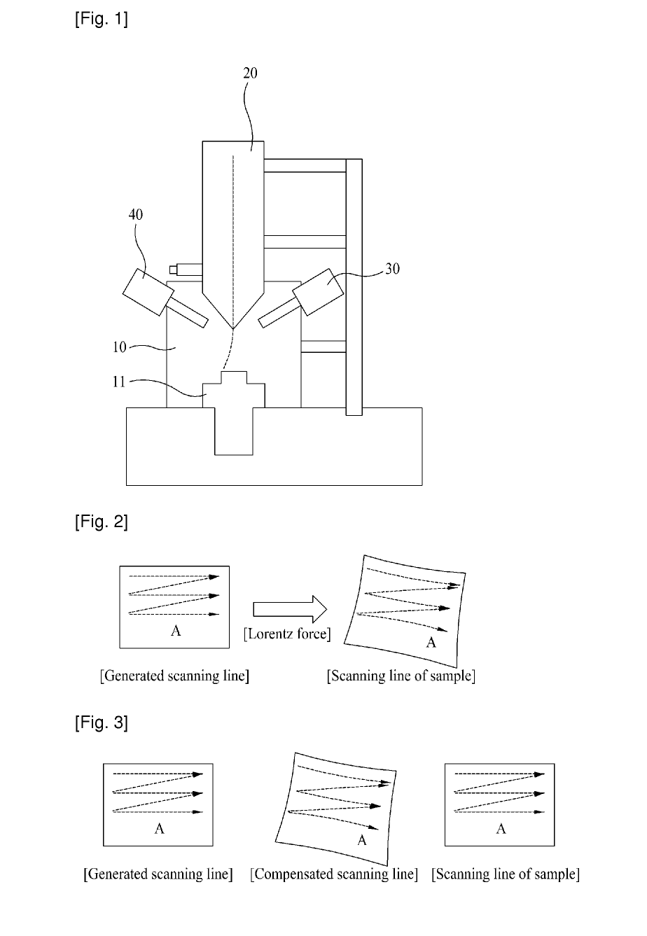

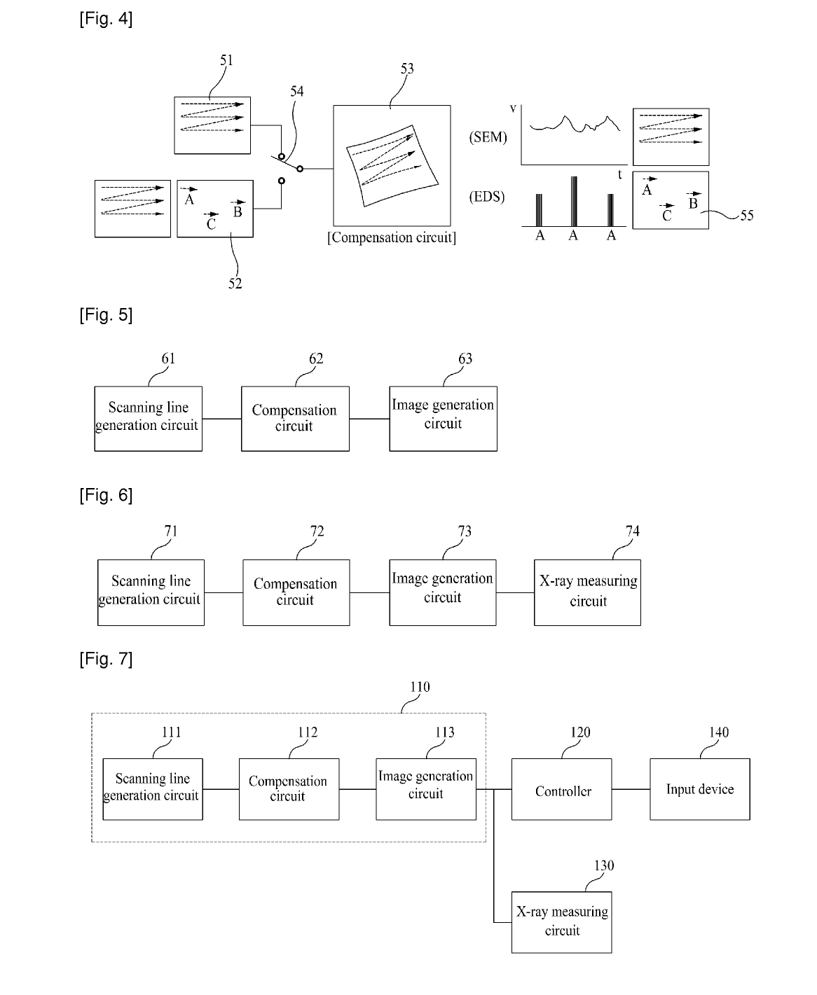

### DESCRIPTIONS ON REFERENCE NUMBERS FOR THE MAJOR COMPONENTS IN THE DRAWINGS

110: image generation means

111: scanning line generation circuit

112: compensation circuit

113: image generation circuit

120: controller

130: x-ray measuring circuit

140: input device

### BEST MODE FOR CARRYING OUT THE INVENTION

A preferred embodiment of the invention will be described in detail below with reference to the accompanying drawings.

FIG. 7 is a schematic block diagram illustrating a combine apparatus of a scanning electron microscope and an energy dispersive x-ray spectroscope according to the present invention.

As shown in FIG. 7, the combine apparatus of the scanning electron microscope and the energy dispersive x-ray spectroscope according to the present invention includes an image generation means 110, a controller 120, and an x-ray measuring circuit 130, and an input device 140.

The image generation means 110 serves to detect electrons emitted from a sample and simultaneously generate a scanning electron microscope image for measuring a shape of the sample and an image for analyzing an x-ray. The generated images can be utilized as an image for analyzing an element through a confirmation of an energy level of a specific position in the energy dispersive x-ray spectroscope as well as an image for measuring a shape of the sample in the scanning electron microscope. Here, since the principle of the image generation of the image generation means 110 is the same as that of the existed scanning electron microscope, the image generation means 110 can be regarded as the scanning electron microscope (SEM).

The above image generation means 110 includes a scanning line generation circuit 111 for generating a scanning line, a compensation circuit 112 for compensating a rotation and a distortion of the generated scanning line, and an image generation circuit 113 for detecting the electrons emitted from the sample after the scanning line compensated by the compensation circuit is scanned on the sample and simultaneously generating the scanning electron microscope image for measuring the sample and the image for analyzing the x-ray.

The controller 120 serves to generate a display control signal and a specific position storing control signal of the image generated from the image generation means 110. That is, the controller 120 serves to generate the next accumulated signal of the image generated from the image generation means 110 as the specific position storing control signal according to the specific position inputted from the input device 140 and generate the next period signal of the image generated from the image generation means 110 as the specific position storing control signal according to the specific position inputted from the input device 140.

Also, the controller 120 allows the image generated from the image generation means 110 to be displayed on a display device. It is preferred that the controller 110 may be a controlling device such as a microcomputer, microprocessor, a controlling apparatus, and a CPU.

The x-ray measuring circuit 130 serves to accumulate only image signals on the specific position of the image generated from the image generation means 110 according to the specific position storing control signal generated by the controller 120 to provide an element information. The x-ray measuring circuit 130 can be regarded as the energy dispersive x-ray spectroscopy.

The input device 140 may be a keyboard or a computer mouse for operating and inputting any signals through a user (operator). The input device 140 serves to select the specific position of the image, input the magnification thereof, or designate the specific position of the image so as to analyze the element of the specific position.

The combine apparatus of the scanning electron microscope and the energy dispersive x-ray spectroscope according to the present invention will be concretely described below.

Firstly, like the method of the image generation for observation of the existed scanning electron microscope, the scanning line generation circuit 111 of the image generation means 110 generates the scanning line so as to emit it on the sample and the compensation circuit 112 compensates the distorted scanning line through the pass of a magnetic lens.

More concretely, the compensation circuit 112 serves to perform a rotation movement value compensation on each working distance (WD), an image distortion compensation generated by the influence of the magnetic field per each working distance (WD), a shearing distortion compensation, and a length compensation. Here, since these methods on the scanning line compensation are already well-known in the field, further descriptions are omitted here.

The scanning line compensated by the compensation circuit is scanned on the sample. Thereafter, the electrons emitted from the sample are detected through the detector and then, the image generation circuit 113 generates the image signal to generate the image for observation and another image for analyzing the element. Then, under the control of the controller 120, the generated image is display on the display device, so that the user can observe the shape of the sample as one image. Here, the generated image is a single image for measuring the shape of the sample of the scanning electron microscope as well as analyzing the element for the energy dispersive x-ray spectroscopy.

In the act of observing the shape of the sample through the display device, if the user wishes to know the element (construction) of the specific position, it can designate the specific position through the input device 140.

Where the specific position is designated through the input device 140, it is a case of requiring the x-ray analysis. Accordingly, the controller 120 allows the specific position storing control signal to be generated in the x-ray measuring circuit 130. In the controller 120, the specific position designated by the user on the region emitted on the sample through the scanning line generation circuit 111 can be seen from the image generated from the image generation circuit 113.

Here, the specific position storing control signal includes the accumulated signal on the specific position for accumulating the specific position and the period signal on the specific position for again returning to the first specific position after the accumulation of the specific position is completed.

For example, in the controller 120, when the specific position accumulation signal is generated as the specific position storing control signal, the x-ray measuring circuit 130 allows only a first specific position accumulation signal in the image generated from the image generation circuit 113 to be accumulated and stored in the specific register. Then, when the first specific position accumulation signal is completed in some degree, the controller 120 generates the next specific position accumulation signal (a second specific position accumulation signal) to provide the x-ray measuring circuit 130 and then, according to the control signal, the x-ray measuring circuit 130 allows the second specific position accumulation signal corresponding to the second specific position transmitted from the image generation circuit 113 to be accumulated and stored in the next specific register. In the process, when the signal accumulations on the specific positions designated by the input device 140 is completed in some degree, the controller 120 transmits the next period signal to the x-ray measuring circuit 130, so that the signal accumulation can be moved to the first specific position. By means of the next period signal, the x-ray measuring circuit 130 is moved to the register corresponding to the first specific position so as to accumulate and store the signals transmitted from the image generation circuit 113.

In this operation, the energy level on the specific position can be accumulated like the existed x-ray spectroscopy. That is, the x-ray measuring circuit 130 is operated equally with the existed x-ray spectroscopy for accumulating the energy level on the specific position.

When the accumulations of the energy level are completed, the x-ray measuring circuit 130 transmits the energy level information to a component analysor similarly with the existed element analysis. Also, the result of the component analysis analyzed in the component analysor is again transmitted to the controller 120.

The controller 120 allows the result of the component analysis to be displayed on the display device.

According to the combine apparatus of the scanning electron microscope and the energy dispersive x-ray spectroscope according to the present invention, the image generation for observation of the scanning electron microscope is implemented in the one board and an x-ray analysis device module for analyzing the element is mounted on the board, so that two functions (scanning electron microscope function and x-ray spectroscope function) can be selected and controlled through the single controller, thereby combining the scanning electron microscope and the energy dispersive x-ray spectroscope. Accordingly, since the scanning electron microscope function and the x-ray spectroscope function can be implemented together in a single product, the manufacturing process is simple and the manufacturing cost can be reduced.

According to another combine apparatus of the scanning electron microscope and the energy dispersive x-ray spectroscope according to the present invention, a board of the scanning electron microscope is separately manufactured and overlapping parts (scanning line generation circuit and image generation circuit) of the scanning electron microscope and the energy dispersive x-ray spectroscope are removed from a board of the x-ray analysor to simply implement only the x-ray measuring circuit for measuring only the x-ray, so that two boards can be combined through the single controller. The existed scanning electron microscope and energy dispersive x-ray spectroscope are separately manufactured. However, in the present invention, since the scanning electron microscope function and the x-ray spectroscope function can be implemented together in a single product, the manufacturing process is simple and the manufacturing cost can be reduced.

Especially, during the manufacturing of the board of the x-ray analysor, since only the x-ray measuring circuit is implemented without implementing the scanning line generation circuit and the image generation circuit overlapped with the scanning electron microscope, the board of the x-ray analysor can be easily implemented and the manufacturing cost thereof can be reduced.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

### INDUSTRIAL APPLICABILITY

The present invention relates to a combine apparatus of a scanning electron microscope and an energy dispersive x-ray spectroscopy in that the scanning electron microscope and the energy dispersive x-ray are combined, whereby unifying as one apparatus.

1. A combine apparatus of a scanning electron microscope and an energy dispersive x-ray spectroscopy comprising:
an image generation means for detecting electrons emitted from a sample for measuring a shape of the sample and simultaneously generating a scanning electron microscope image for analyzing an x-ray;
a controller for generating a display control signal and a specific position storing control signal of the image generated from the image generation means; and
an x-ray measuring circuit for accumulating an energy level on a specific position of the image generated from the image generation means according to the specific position storing control signal generated by the controller to provide an element information thereof.

2. A combine apparatus of a scanning electron microscope and an energy dispersive x-ray spectroscopy as set forth in claim 1, wherein the image generation means is the scanning electron microscope for detecting the electrons emitted from the sample and generating the image for measuring the shape of the sample.

3. A combine apparatus of a scanning electron microscope and an energy dispersive x-ray spectroscopy as set forth in claim 2, wherein the image generation means comprises: a scanning line generation circuit for generating a scanning line, a compensation circuit for compensating a rotation and a distortion of the generated scanning line, and an image generation circuit for detecting the electrons emitted from the sample after the scanning line compensated by the compensation circuit is scanned on the sample and simultaneously generating the scanning electron microscope image for measuring the sample and the image for analyzing the x-ray.

4. A combine apparatus of a scanning electron microscope and an energy dispersive x-ray spectroscopy as set forth in claim 1, wherein the controller allows the next accumulated signal or the next period signal to be provided to the x-ray measuring circuit as the specific position storing control signal.

5. A combine apparatus of a scanning electron microscope and an energy dispersive x-ray spectroscopy as set forth in claim 1, wherein the x-ray measuring circuit is the energy dispersive x-ray spectroscopy for utilizing the image provided from the scanning electron microscope without being equipped with a separate image generation means.
